(19) United States
(12) Patent Application Publication
(10) Pub. No.: US 2024/0021183 A1
(43) Pub. Date: Jan. 18, 2024

(54) SINGING SOUND OUTPUT SYSTEM AND METHOD

(71) Applicant: Yamaha Corporation, Hamamatsu (JP)

(72) Inventor: Tatsuya IRIYAMA, Hamamatsu (JP)

(21) Appl. No.: 18/475,309

(22) Filed: Sep. 27, 2023

Related U.S. Application Data
(63) Continuation of application No. PCT/JP2021/013379, filed on Mar. 29, 2021.

(51) Int. Cl. G10H 1/36

(52) U.S. Cl. CPC G10H 1/366; G10H 2220/011; G10H 2240/325; G10H 2250/455; G10L 13/04

(57) ABSTRACT

A singing sound output system includes at least one processor configured to execute a teaching unit configured to indicate to a user a progression position in singing data that are temporally associated with accompaniment data and include a plurality of syllables, an acquisition unit configured to acquire at least one piece of sound information input by a performance, a syllable identification unit configured to identify, from the syllables in the singing data, a syllable corresponding to the sound information, a timing identification unit configured to associate, with the sound information, relative information indicating a relative timing with respect to an identified syllable identified by the syllable identification unit, a synthesizing unit configured to synthesize a singing sound based on the identified syllable, and an output unit configured to, based on the relative information, synchronize and output the singing sound and an accompaniment sound based on the accompaniment data.

### CROSS-REFERENCE TO RELATED APPLICATIONS

This application is a continuation application of International Application No. PCT/JP2021/013379, filed on Mar. 29, 2021. The entire disclosures of International Application No. PCT/JP2021/013379 are hereby incorporated herein by reference.

### BACKGROUND

### Technological Field

This disclosure relates to a singing sound output system and method for outputting singing sounds.

### Background Information

A technology for generating singing sounds in response to performance operations is known. For example, the singing sound synthesizer disclosed in Japanese Laid-Open Patent Application No. 2016-206323 generates singing sounds by advancing through lyrics one character or one syllable at a time in response to a real-time performance.

### SUMMARY

However, Japanese Laid-Open Patent Application No. 2016-206323 does not disclose the outputting of singing sounds together with an accompaniment in real time. If singing sounds were to be output together with an accompaniment in real time, it would be difficult to accurately generate singing sounds at the originally intended timing. For example, even if performance operations were started at the intended timing of sound generation, the actual start of singing would be delayed because of the processing time required from synthesis to pronunciation of the singing sounds. Therefore, there is room for improvement regarding the outputting of singing sounds at the intended timing in accordance with an accompaniment.

An object of this disclosure is to provide a singing sound output system and method that can output singing sounds at the timing at which sound information is input, in synchronization with the accompaniment.

An embodiment of this disclosure provides a singing sound output system, comprising at least one processor configured to execute a plurality of units including a teaching unit configured to indicate to a user a progression position in singing data that are temporally associated with accompaniment data and that include a plurality of syllables, an acquisition unit configured to acquire at least one piece of sound information input by a performance, a syllable identification unit configured to identify, from the plurality of syllables in the singing data, a syllable corresponding to the at least one piece of sound information acquired by the acquisition unit, a timing identification unit configured to associate, with the at least one piece of sound information, relative information indicating a relative timing with respect to an identified syllable that has been identified by the syllable identification unit, a synthesizing unit configured to synthesize a singing sound based on the identified syllable, and an output unit configured to, based on the relative information, synchronize and output the singing sound synthesized by the synthesizing unit and an accompaniment sound based on the accompaniment data.

### BRIEF DESCRIPTION OF THE DRAWINGS

FIG. 1 is a diagram showing the overall configuration of a singing sound output system according to a first embodiment.

FIG. 2 is a block diagram of the singing sound output system.

FIG. 3 is a functional block diagram of the singing sound output system.

FIG. 4 is a timing chart of a process for outputting a singing sound by a performance.

FIG. 5 is a flowchart showing system processing.

FIG. 6 is a timing chart of a process for outputting singing sounds by a performance.

FIG. 7 is a flowchart showing system processing.

### DETAILED DESCRIPTION OF THE EMBODIMENTS

Embodiments of this disclosure are described below with reference to the drawings. It will be apparent to those skilled from this disclosure that the following descriptions of the embodiments are provided for illustration only and not for the purpose of limiting the invention as defined by the appended claims and their equivalents.

### First Embodiment

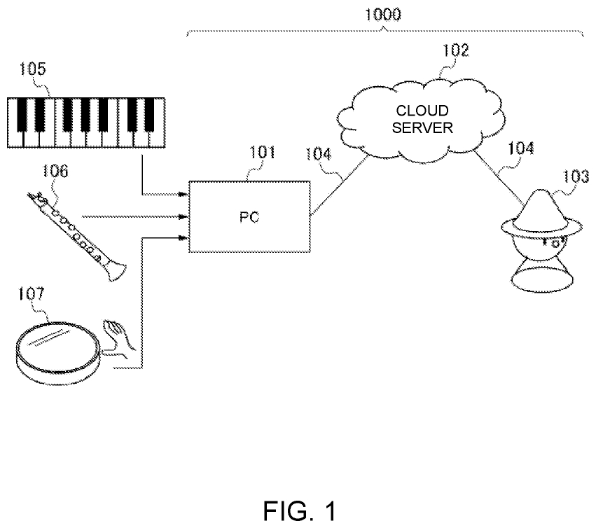

FIG. 1 is a diagram showing the overall configuration of a singing sound output system according to a first embodiment of this disclosure. This singing sound output system 1000 includes a PC (personal computer) 101, a cloud server 102, and a sound output device 103. The PC 101 and the sound output device 103 are connected so as to be capable of communicating with the cloud server 102 by a communication network 104, such as the Internet. In an environment in which the PC 101 is used, a keyboard 105, a wind instrument 106, and a drum 107 are present as items and devices for inputting sound.

The keyboard 105 and the drum 107 are electronic instruments used for inputting MIDI (Musical Instrument Digital Interface) signals. The wind instrument 106 is an acoustic instrument used for inputting monophonic analog sounds. The keyboard 105 and the wind instrument 106 can also input pitch information. The wind instrument 106 can be an electronic instrument, and the keyboard 105 and the drum 107 can be acoustic instruments. These instruments are examples of devices for inputting sound information and are played by a user on the PC 101 side. A vocalization by the user on the PC 101 side can also be used as a means for inputting analog sound, in which case the physical voice is input as an analog sound. Therefore, the concept of “performance” for inputting sound information in the present embodiment includes input of actual voice. In addition, the device for inputting sound information need not be in the form of a musical instrument.

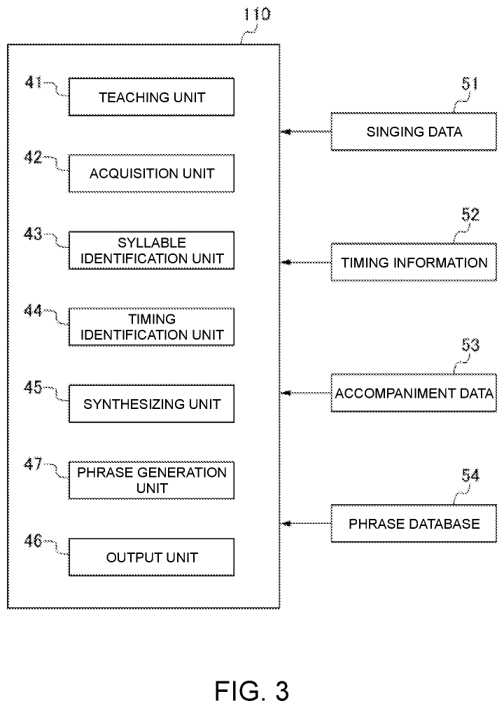

Although details will be described further below, an overview of a typical process of the singing sound output system 1000 will be described. A user on the PC 101 side plays a musical instrument while listening to an accompaniment. The PC 101 transmits singing data 51, timing information 52, and accompaniment data 53 (all of which will be described further below in connection with FIG. 3) to the cloud server 102. The cloud server 102 synthesizes singing sounds based on sound generated by the performance of the user on the PC 101 side. The cloud server 102 transmits the singing sounds, the timing information 52, and the accompaniment data 53 to the sound output device 103. The sound output device 103 is a device equipped with a speaker function. The sound output device 103 outputs the singing sounds and accompaniment data 53 that have been received. At this time, the sound output device 103 synchronizes and outputs the singing sound and the accompaniment data 53 based on the timing information 52. The form of “output” here is not limited to reproduction, and can include transmission to an external device or storage on a storage medium.

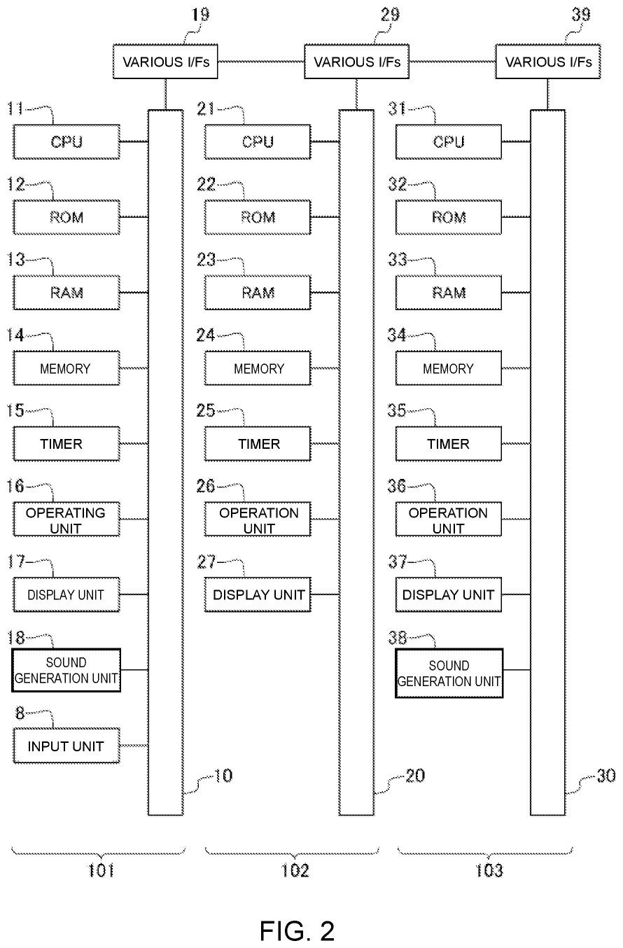

FIG. 2 is a block diagram of the singing sound output system 1000. The PC 101 includes CPU (Central Processing Unit) 11, ROM (Read Only Memory) 12, RAM (Random Access Memory) 13, a memory 14, a timer 15, an operation unit 16, a display unit 17, a sound generation unit 18, an input unit 8, and various I/Fs (interfaces) 19. These constituent elements are interconnected by a bus 10.

The CPU 11 controls the entire PC 101. The CPU 11 is one example of at least one processor as an electronic controller of the PC 101. Here, the term “electronic controller” as used herein refers to hardware, and does not include a human. The PC 101 can include, instead of the CPU 11 or in addition to the CPU 11, one or more types of processors, such as a GPU (Graphics Processing Unit), a DSP (Digital Signal Processor), an FPGA (Field Programmable Gate Array), an ASIC (Application Specific Integrated Circuit), and the like.

The ROM 12 stores various data in addition to a program executed by the CPU 11. The RAM 13 provides a work area when the CPU 11 executes a program. The RAM 13 temporarily stores various information. The memory 14 (computer memory) includes non-volatile memory. The timer 15 measures time. The timer 15 can employ a counter method. The operation unit (user operable input) 16 includes a plurality of operators for inputting various types of information and receives instructions from a user. The display unit (display) 17 displays various information. The sound generation unit (sound generator) 18 includes a sound source circuit, an effects circuit, and a sound system.

The input unit 8 includes an interface for acquiring sound information from devices for inputting electronic sound information, such as the keyboard 105 and the drum 107. The input unit 8 also includes devices such as a microphone for acquiring sound information from devices for inputting acoustic sound information, such as the wind instrument 106. The various I/Fs 19 connect to the communication network 104 (FIG. 1) by wire or wirelessly.

The cloud server 102 includes CPU (Central Processing Unit) 21, ROM (Read Only Memory) 22, RAM (Random Access Memory) 23, a memory 24, a timer 25, an operation unit 26, a display unit 27, a sound generation unit 28, and various I/Fs 29. These constituent elements are interconnected by a bus 20. The configurations of these constituent elements are the same as those indicated by reference numerals 11-17 and 19 in the PC 101.

The sound output device 103 includes CPU (Central Processing Unit) 31, ROM (Read Only Memory) 32, RAM (Random Access Memory) 33, a memory 34, a timer 35, an operation unit 36, a display unit 37, a sound generation unit 38, and various I/Fs 39. These constituent elements are interconnected by a bus 30. The configurations of these constituent elements are the same as those indicated by reference numerals 11-19 in the PC 101.

FIG. 3 is a functional block diagram of the singing sound output system 1000. The singing sound output system 1000 includes a functional block 110. The functional block 110 includes a teaching unit 41, an acquisition unit 42, a syllable identification unit 43, a timing identification unit 44, a synthesizing unit 45, an output unit 46, and a phrase generation unit 47 as individual functional units.

In the present embodiment, for example, each function of the teaching unit 41 and the acquisition unit 42 is realized by the PC 101. Each of these functions is realized by software by programs stored in the ROM 12. That is, each function is provided by the CPU 11 extracting the necessary program, executing various computations in the RAM 13, and controlling hardware resources. In other words, these functions are realized by cooperation primarily between the CPU 11, the ROM 12, the RAM 13, the timer 15, the display unit 17, the sound generation unit 18, the input unit 8, and the various I/Fs 19. The programs executed here include sequencer software.

In addition, the functions of the syllable identification unit 43, the timing identification unit 44, the synthesizing unit 45, and the phrase generation unit 47 are realized by the cloud server 102. Each of these functions is implemented in software by a program stored in the ROM 22. These functions are realized by cooperation primarily between the CPU 21, the ROM 22, the RAM 23, the timer 25, and the various I/Fs 29.

In addition, the function of the output unit 46 is realized by the sound output device 103. The function of the output unit 46 is implemented in software by a program stored in the ROM 32. These functions are realized by cooperation primarily between the CPU 31, the ROM 32, the RAM 33, the timer 35, the sound generation unit 38, and the various I/Fs 39.

The singing sound output system 1000 refers to the singing data 51, the timing information 52, the accompaniment data 53, and a phrase database 54. The phrase database 54 is stored in the ROM 12, for example. The phrase generation unit 47 and the phrase database 54 are not essential to the present embodiment. These elements will be described in connection with the third embodiment.

The singing data 51, the timing information 52, and the accompaniment data 53 are associated with each other for each song and stored in the ROM 12 in advance. The accompaniment data 53 are information for reproducing the accompaniment of each song stored as sequence data. The singing data 51 include a plurality of syllables. The singing data 51 include lyrics text data and a phonological information database. The lyrics text data are data describing lyrics, in which the lyrics of each song is described, divided into units of syllables. In each song, the accompaniment position in the accompaniment data 53 and the syllable in the singing data 51 are temporally associated with each other by the timing information 52.

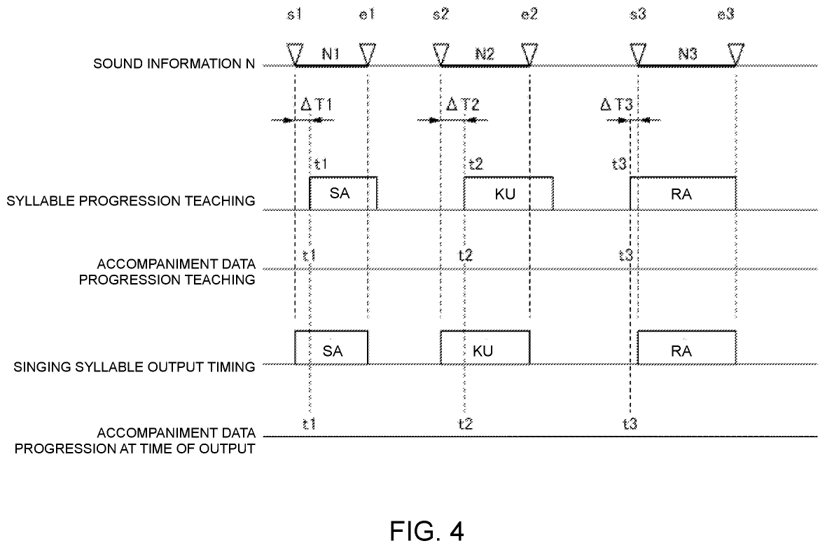

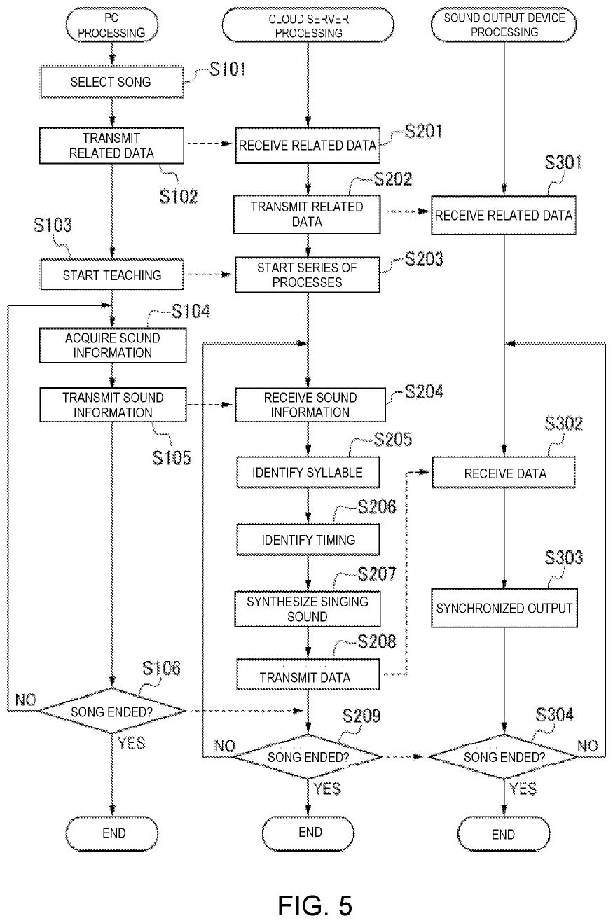

The processes carried out by each functional unit in the functional block 110 will be described in detail in FIGS. 4 and 5. An outline is described here. The teaching unit 41 shows (teaches) the user the progression position in the singing data 51. The acquisition unit 42 acquires at least one piece of sound information N (see FIG. 4) input by a performance. The syllable identification unit 43 identifies the syllable corresponding to the acquired sound information N from the plurality of syllables in the singing data 51. The timing identification unit 44 associates the difference ΔT (see FIG. 4) with the sound information N as relative information indicating the relative timing with respect to the identified syllable. The synthesizing unit 45 synthesizes a singing sound based on the identified syllable. The output unit 46 synchronizes and outputs the synthesized singing sound and the accompaniment sound based on the accompaniment data 53 based on the relative information described above.

FIG. 4 is a timing chart of a process for outputting singing sounds by a performance. When a song is selected and a process is started, a syllable corresponding to the progression position in the singing data 51 is shown to the user on PC 101, as shown in FIG. 4. For example, the syllables are displayed in order, such as “sa,” “ku,” and “ra.” A pronunciation start timing t (t1-t3) is defined by a temporal correspondence relationship with the accompaniment data 53, and is the original syllable pronunciation start timing defined in the singing data 51. For example, time t1 indicates a pronunciation start position of the syllable “sa” in the singing data 51. An accompaniment based on the accompaniment data 53 progresses in parallel with the teaching of the syllable progression.

The user performs in accordance with the indicated syllable progression. Here, an example is given in which a MIDI signal is inputted by performance of the keyboard 105 that can input pitch information. The user, who is the performer, sequentially presses keys corresponding to the syllables in time with the start of each of the syllables “sa,” “ku,” and “ra.” In this manner, sound information N (N1-N3) is acquired sequentially. The pronunciation length of each piece of sound information N is the time from an input start timing s (s1-s3) to an input end timing e (e1-e3). The input start timing s corresponds to note-on and the input end timing e corresponds to note-off. The sound information N includes pitch information and velocity.

The user can intentionally shift the actual input start timing s from the pronunciation start timing t. In the cloud server 102, the shift time of the input start timing s with respect to the pronunciation start timing t is calculated as the temporal difference ΔT (ΔT1-T3) (relative information). The difference ΔT is calculated for and is associated with each syllable. The cloud server 102 synthesizes a singing sound based on the sound information N and sends the synthesized singing sound to the sound output device 103 together with the accompaniment data 53.

The sound output device 103 synchronizes and outputs the singing sound and the accompaniment sound based on the accompaniment data 53. At this time, the sound output device 103 outputs the accompaniment sound at a set constant tempo. The sound output device 103 outputs singing sounds such that each syllable matches the accompaniment position based on the timing information 52. Note that processing time is required from the input of sound information N to the output of the singing sound. Thus, the sound output device 103 delays the output of the accompaniment sound using delay processing in order to match each syllable with the accompaniment position.

For example, the sound output device 103 adjusts the output timing by referring to the difference ΔT corresponding to each syllable. As a result, the output of the singing sound is started in accordance with the input timing (at input start timing s). For example, the output (pronunciation) of the syllable “ku” is started at a timing that is earlier than the pronunciation start timing t2 by the difference ΔT2. In addition, the output (pronunciation) of the syllable “ra” is started at a timing that is later than the pronunciation start timing t3 by the difference ΔT3. The pronunciation of each syllable ends (is muted) at a time corresponding to the input end timing e. Therefore, the accompaniment sounds are output at a fixed tempo, and the singing sounds are output at timings corresponding to the performance timings. Therefore, the singing sound can be synchronized with the accompaniment and output at the timing when the sound information N is input.

FIG. 5 is a flowchart showing the system processing for outputting a singing sound by a performance executed by the singing sound output system 1000. In this system processing, PC processing executed by PC 101, cloud server processing executed by the cloud server 102, and sound output device processing executed by the sound output device 103 are executed in parallel. The PC processing is realized by the CPU 11 extracting a program stored in the ROM 12 and executing the program in the RAM 13. The cloud server processing is realized by the CPU 21 extracting a program stored in the ROM 22 and executing the program in the RAM 23. The sound output device processing is realized by the CPU 31 extracting a program stored in the ROM 32 and executing the program in the RAM 33. Each of these processes is started when the start of system processing is indicated in the PC 101.

The PC processing will be described first. In Step S101, the CPU 11 of the PC 101 selects a song to be played at this time (hereinafter referred to as selected song) from among a plurality of prepared songs based on an instruction from the user. The performance tempo of the song is set in advance by default for each song. However, the CPU 11 can change the tempo to be set based on an instruction from the user when the song to be performed is selected.

In Step S102, the CPU 11 transmits related data corresponding to the selected song (singing data 51, timing information 52, accompaniment data 53) via the various I/Fs 19.

In Step S103, the CPU 11 initiates the teaching of the progression position. Therefore, the CPU 11 sends a notification to the cloud server 102 indicating that the teaching of the progression position has been initiated. The teaching process here is realized by executing sequencer software, for example. The CPU 11 (teaching unit 41) teaches the current progression position by using the timing information 52.

For example, the display unit 17 displays lyrics corresponding to the syllables in the singing data 51. The CPU 11 teaches the progression position on the displayed lyrics. For example, the teaching unit 41 varies the display mode of the lyrics of the current position, such as color, or moves the current position or the position of the lyrics themselves to indicate the progression position. Furthermore, the CPU 11 reproduces the accompaniment data 53 at the set tempo to indicate the progression position. The method for indicating the progression position is not limited to these examples, and various methods of visual or auditory recognition can be employed. For example, a method of indicating the note of the current position on a displayed musical score can be employed. Alternatively, after the start timing is indicated, a metronome sound can be generated. At least one method can be employed, but a plurality of methods can also be used in combination.

In Step S104, the CPU 11 (acquisition unit 42) executes a sound information acquisition process. For example, the user performs along with the lyrics while checking the progression position that has been taught (for example, while listening to the accompaniment). The CPU 11 acquires analog sound or MIDI data produced by the performance as sound information N. Sound information N typically includes input start timing s, input end timing e, pitch information, and velocity information. Note that pitch information is not necessarily included, as is the case when the drum 107 is played. The velocity information can be canceled. The input start timing s and input end timing e are defined by the time relative to the accompaniment progression. In the case that analog sound, such as the physical voice, is acquired with a microphone, audio data are acquired as the sound information N.

In Step S105, the CPU 11 sends the sound information N acquired in Step S104 to the cloud server 102. In Step S106, it is determined whether the selected song has ended, that is, whether teaching of the progression position has been completed to the final position in the selected song. Then, if the selected song has not ended, the CPU 11 returns to Step S104. Therefore, the sound information N acquired in accordance with the performance along with the progression of the song is sent to the cloud server 102 as needed until the selected song has ended. When the selected song ends, the CPU 11 sends a notification to that effect to the cloud server 102 and terminates the PC processing.

The cloud server processing will now be described. In Step S201, when related data corresponding to the selected song are received via the various I/Fs 29, the CPU 21 of the cloud server 102 proceeds to Step S202. In Step S202, the CPU 21 transmits the related data that have been received to the sound output device 103 via the various I/Fs 29. It is not necessary to transmit the singing data 51 to the sound output device 103.

In Step S203, the CPU 21 starts a series of processes (S204-S209). In starting this series of processes, the CPU 21 executes the sequencer software and uses the related data that have been received to advance the time while waiting for the reception of the next sound information N. In Step S204, the CPU 21 receives the sound information N.

In Step S205, the CPU 21 (syllable identification unit 43) identifies the syllable corresponding to the sound information N that have been received. First, the CPU 21 calculates for each syllable the difference ΔT between the input start timing s in the sound information N and the pronunciation start timing tin each of a plurality of syllables in the singing data 51 corresponding to the selected song. The CPU 21 then identifies the syllable with the smallest difference ΔT from among the plurality of syllables in the singing data 51 as the syllable corresponding to the sound information N received this time.

For example, in the example shown in FIG. 4, regarding the sound information N2, the difference ΔT2 between input start timing s2 and pronunciation start timing t2 of the syllable “ku” is smallest compared to the differences for the other syllables. Therefore, the CPU 21 identifies the syllable “ku” as the syllable corresponding to sound information N2. In this manner, for each piece of sound information N, the syllable corresponding to the pronunciation start timing t that is closest to the input start timing s is identified as the corresponding syllable.

In the case that the sound information N is audio data, the CPU 21 (syllable identification unit 43) determines the pronunciation/muting timing, tone height (pitch) and the velocity of the sound information N.

In Step S206, the CPU 21 (timing identification unit 44) executes a timing identification process. That is, the CPU 21 associates the difference ΔT with respect to sound information N received this time and the syllable identified as the syllable corresponding to the sound information N.

In Step S207, the CPU 21 (synthesizing unit 45) synthesizes a singing sound based on the identified syllable. The pitch of the singing sound is determined based on the pitch information of the corresponding sound information N. In the case that sound information N is the sound of a drum, the pitch of the singing sound can be a constant pitch, for example. Regarding the singing sound output timing, the pronunciation timing and the muting timing are determined based on input end timing e (or the pronunciation length) and pronunciation start timing t of the corresponding sound information N. Therefore, a singing sound is synthesized from the syllable corresponding to the sound information N and the pitch determined by the performance. Note that there are cases in which the pronunciation period of the current syllable overlaps with the original pronunciation timing of the next syllable in the singing data because the sound during the performance was muted too late. In this case, the input end timing e can be corrected so that the sound is forcibly muted before the original pronunciation timing of the next syllable.

In Step S208, the CPU 21 executes data transmission. That is, the CPU 21 transmits the synthesized singing sound, the difference ΔT corresponding to the syllable, and the velocity information at the time of performance to the sound output device 103 via the various I/Fs 29.

In Step S209, the CPU 21 determines whether the selected song has ended, that is, whether a notification indicating that the selected song has ended has been received from the PC 101. Then, if the selected song has not ended, the CPU 21 returns to Step S204. Therefore, until the selected song ends, singing sounds based on the syllables corresponding to sound information N are synthesized and transmitted as needed. The CPU 21 can determine that the selected song has ended when a prescribed period of time has elapsed after the processing of the last received sound information N has ended. When the selected song ends, CPU 21 terminates the cloud server processing.

The sound output device processing will now be described. In Step S301, when related data corresponding to the selected song are received via the various I/Fs 39, the CPU 31 of the sound output device 103 proceeds to Step S302. In Step S302, the CPU 31 receives the data (singing sound, difference ΔT, velocity) transmitted from the cloud server 102 in Step S208.

In Step S303, the CPU 31 (output unit 46) performs the synchronized output of the singing sound and the accompaniment based on the received singing sound and difference ΔT, the already received accompaniment data 53, and the timing information 52.

As described in FIG. 4, the CPU 31 outputs the accompaniment sound based on the accompaniment data 53, and, in parallel therewith, outputs the singing sound while adjusting the output timing based on the timing information and the difference ΔT. Here, reproduction is employed as a representative mode of synchronized output of the accompaniment sound and the singing sound. Therefore, the sound output device 103 can listen to the user's performance of the PC 101 in synchronization with the accompaniment.

Note that the mode of the synchronized output is not limited to reproduction, but the output can be stored in the memory 34 as an audio file or transmitted to an external device through the various I/Fs 39.

In Step S304, the CPU 31 determines whether the selected song has ended, that is, whether a notification indicating that the selected song has ended has been received from the cloud server 102. If the selected song has not ended, the CPU 31 then returns to Step S302. Therefore, the synchronized output of the singing sound that has been received is continued until the selected song ends. The CPU 31 can determine that the selected song has ended when a prescribed period of time has elapsed after the processing of the last received data has ended. When the selected song ends, the CPU 31 terminates the sound output device processing.

By the present embodiment, the syllable corresponding to the sound information N acquired while the progression position in the singing data 51 is being indicated to the user is identified from the plurality of syllables in the singing data 51. The relative information (difference ΔT) is associated with the sound information N, and the singing sound is synthesized based on the identified syllable. The singing sound and the accompaniment sound based on the accompaniment data 53 are synchronized and output based on the relative information. Therefore, the singing sound can be synchronized with the accompaniment and output at the timing at which the sound information N is input.

Also, in the case that the sound information N included pitch information, the singing sound can be output at the pitch input by the performance. In the case that the sound information N also includes velocity information, the singing sound can be output at a volume corresponding to the intensity of the performance.

Although the related data (singing data 51, timing information 52, accompaniment data 53) are transmitted to the cloud server 102 or the sound output device 103 after the selected song is determined, no limitation is imposed thereby. For example, the related data of a plurality of songs can be pre-stored in the cloud server 102 or the sound output device 103. Then, when the selected song is determined, information specifying the selected song can be transmitted to the cloud server 102 and also to the sound output device 103.

### Second Embodiment

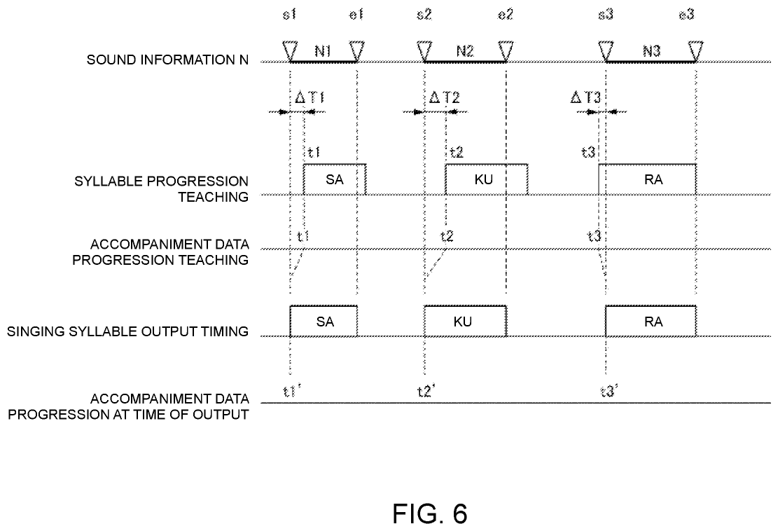

In the second embodiment of this disclosure, a part of the system processing differs from the first embodiment. Therefore, the differences from the first embodiment are primarily described with reference to FIGS. 5 and 6. In the first embodiment, the performance tempo was fixed, but in the present embodiment, the performance tempo is variable and changes in response to the performance by the performer.

FIG. 6 is a timing chart of a process for outputting singing sounds by a performance. The order of the plurality of syllables in the singing data 51 is predetermined. In FIG. 6, in the display of the progression of syllables, the singing sound output system 1000 indicates the next syllable in the singing data to the user while awaiting the input of sound information N, and each time sound information N is input, the syllable indicating the progression position (indication syllable) is advanced by one to the next syllable (following syllable following the indication syllable). Therefore, the syllable progression display will wait until there is a performance input corresponding to the next syllable. The teaching of the accompaniment data progression also waits until there is a performance input in conjunction with the syllable progression.

The cloud server 102 identifies the syllable that was next in the order of progression at the time the sound information N was input as the syllable corresponding to the sound information N that has been input. Therefore, with each key-on, the corresponding syllable is identified in turn.

The actual input start timing s can deviate relative to the pronunciation start timing t. In the same manner as in the first embodiment, the shift time of the input start timing s with respect to the pronunciation start timing t is calculated in the cloud server 102 as the temporal difference ΔT (ΔT1-T3) (relative information). The difference ΔT is calculated for each syllable and associated with it. The cloud server 102 synthesizes a singing sound based on the sound information N and sends it together with the accompaniment data 53 to the sound output device 103.

In FIG. 6, syllable pronunciation start timing t′ (t1′-t3′) is the pronunciation start timing of the syllable at the time of output. The syllable pronunciation start timing t′ is determined by the input start timing s. The progression of the accompaniment sound at the time of output also continually changes at any time depending on the syllable pronunciation start timing t′.

The sound output device 103 outputs the singing sound and the accompaniment sound based on the accompaniment data 53 in synchronized fashion, by outputting the singing sound while adjusting the output timing based on the timing information and the difference ΔT. At this time, the sound output device 103 outputs the singing sound at the syllable pronunciation start timing t′. Regarding the accompaniment sound, the sound output device 103 outputs each syllable matched to the accompaniment position based on the difference ΔT. In order to match each syllable to the accompaniment position, the sound output device 103 uses the delay process to delay the output of the accompaniment sound. Therefore, the singing sound is output at a timing corresponding to the performance timing, and the tempo of the accompaniment sound changes in accordance with the performance timing.

The system processing in the present embodiment will be described with reference to the flowchart of FIG. 5. Parts that are not specifically mentioned are the same as those in the first embodiment.

In the teaching process initiated at Step S103 by the PC 101, the CPU 11 (teaching unit 41) uses the timing information 52 to teach the current progression position. In Step S104, the CPU 11 (acquisition unit 42) executes a sound information acquisition process. The user plays and inputs the sound corresponding to the next syllable while checking the progression position. The CPU 11 awaits the progression of the accompaniment and the progression of the teaching of the syllables until there is input of the next sound information N. Therefore, the CPU 11 teaches the next syllable while waiting for the input of the sound information N, and each time the sound information N is input, advances the syllable indicating the progression position one step to the next syllable. The CPU 11 also matches the accompaniment progression to the progression of the teaching of the syllables.

In the series of processes that is started in Step S203 in the cloud server 102, the CPU 21 advances the time while waiting for the reception of sound information N. In Step S204, the CPU 21 continually receives sound information N and advances the time as sound information N is received. Therefore, the CPU 21 waits for time to pass until the next sound information N is received.

When the sound information N is received, the CPU 21 (syllable identification unit 43) in Step S205 identifies the syllable corresponding to the sound information N that has been received. Here, the CPU 21 identifies the syllable that was next in the order of progression at the time the sound information N was input as the syllable corresponding to the sound information N that has been received this time. Therefore, with each key-on due to the performance, the corresponding syllable is identified in turn.

After a syllable is identified, in Step S206, the CPU 21 calculates the difference ΔT and associates this difference with the identified syllable. That is, as shown in FIG. 6, the CPU 21 as calculates the shift time of the input start timing s with respect to the pronunciation start timing t corresponding to the identified syllable the difference ΔT. The CPU 21 then associates the obtained difference ΔT with the identified syllable.

In the data transmission in Step S208, the CPU 21 transmits the synthesized singing sound, the difference ΔT corresponding to the syllable, and the velocity information at the time of performance to the sound output device 103 via the various I/Fs 29.

In the synchronized output process performed by the sound output device 103 in Step S303, the CPU 31 (output unit 46) synchronously outputs the singing sound and the accompaniment based on the singing sound and the difference ΔT that have been received, the accompaniment data 53 that have already been received, and the timing information 52. At this time, the CPU 31 performs the output process while matching each syllable to the accompaniment position by adjusting the output timings of the accompaniment sound and the singing sound with reference to the difference ΔT.

As a result, as shown in FIG. 6, the output of the singing sound is initiated in accordance with the input timing (at the input start timing s). For example, the output (pronunciation) of the syllable “ku” is started at a timing that is earlier than the pronunciation start timing t2 by the difference ΔT2. In addition, the output (pronunciation) of the syllable “ra” is started at a timing following the pronunciation start timing t3 by the difference ΔT3. The pronunciation of each syllable ends at a time corresponding to the input end timing e.

On the other hand, the performance tempo of the accompaniment sound changes in accordance with the performance timing. For example, with respect to the accompaniment sound, the CPU 31 corrects the position of the pronunciation start timing t2 to the position of the syllable pronunciation start timing t2′, and outputs the accompaniment sound.

Accordingly, the accompaniment sound is output at a variable tempo and the singing sound is output at the timing corresponding to the performance timing. Therefore, the singing sound can be synchronized with the accompaniment and output at the timing at which the sound information N is input.

By the present embodiment, the teaching unit 41 indicates the next syllable while waiting for the input of sound information N, and each time sound information N is input, advances the syllable indicating the progression position by one to the next syllable. The syllable identification unit 43 then identifies the syllable that was next in the order of progression at the time sound information N was input as the syllable corresponding to the sound information N that has been input. Thus, it is possible to exhibit the same effect as the first embodiment in terms of outputting the singing sound at a timing at which the sound information N is input, in synchronization with the accompaniment. In addition, even if the user performs at a free tempo, the singing sound can be output synchronously with the accompaniment according to the user's performance tempo.

In the first and second embodiments, the relative information to be associated with the sound information N is not limited to the difference ΔT. For example, the relative information indicating the relative timing with respect to the identified syllable can be the relative time of the sound information N and the relative time of each syllable based on a certain time defined by the timing information 52.

### Third Embodiment

The third embodiment of this disclosure will be described with reference to FIGS. 1-3, and 7. If singing sounds can be produced using a device that cannot input pitch information, such as a drum, enjoyment will increase. Thus, in the present embodiment, the drum 107 is used for performance input. In the present embodiment, if the user freely strikes and plays the drum 107 without teaching the progression of syllables or the accompaniment, a singing phrase is generated for each unit of a series of sound information N acquired thereby. The basic configuration of the singing sound output system 1000 is the same as that of the first embodiment. In the present embodiment, performance input by the drum 107 is assumed, and it is presumed that there is no pitch information, so that control different from that of the first embodiment is applied.

In the present embodiment, the teaching unit 41, the timing identification unit 44, the singing data 51, the timing information 52, and the accompaniment data 53 shown in FIG. 3 are not essential. The phrase generation unit 47 analyzes the accents of a series of sound information N from the velocity of each piece of sound information N in the series of sound information N and generates a phrase composed of a plurality of syllables corresponding to the series of sound information N based on said accents. The phrase generation unit 47 extracts a phrase matching the accents from the phrase database 54 that includes a plurality of phrases that are prepared in advance to generate the phrase corresponding to the series of sound information N. A phrase having the number of syllables constituting the series of sound information N is extracted.

Here, the accents of the series of sound information N refer to strong/weak accents based on the relative intensity of sound. The accent of a phrase refers to high/low accents based on the relative height of the pitch of each syllable Therefore, the intensity of sound of the sound information N corresponds to the high/low of the pitch of the phrase.

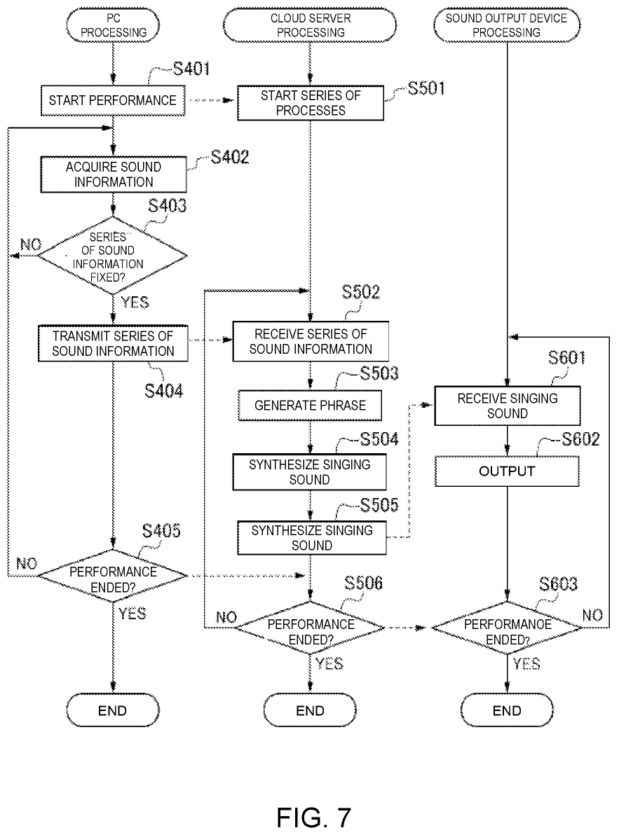

FIG. 7 is a flowchart showing the system processing for outputting singing sounds by a performance executed by the singing sound output system 1000. In this system processing, the execution entities, execution conditions, and starting conditions for the PC processing, cloud server processing, and sound output device processing are the same as those of the system processing shown in FIG. 5.

The PC processing will be described first. In Step S401, the CPU 11 of the PC 101 transitions to a performance start state based on the user's instruction. At this time, the CPU 11 transmits a notification of a transition to the performance start state to the cloud server 102 via the various I/Fs 19.

In Step S402, when the user strikes the drum 107, the CPU 11 (acquisition unit 42) acquires the corresponding sound information N. The sound information N is MIDI data or analog sound. The sound information N includes at least information indicating the input start timing (strike-on) and information indicating velocity.

In Step S403, the CPU 11 (acquisition unit 42) determines whether the current series of sound information N has been finalized. For example, in the case that the first sound information N is input within a first prescribed period of time after transition to the performance start state, the CPU 11 determines that the series of sound information N has been finalized when a second prescribed period of time has elapsed since the last sound information N was input. Although a series of sound information N is assumed to be a collection of a plurality of pieces of sound information N, it can be one piece of sound information N.

In Step S404, the CPU 11 transmits the series of sound information N that has been acquired to the cloud server 102. In Step S405, the CPU 11 determines whether the user has indicated the end of the performance state. The CPU 11 then returns to Step S402 if the end of the performance has not been indicated, and if the end of the performance has been indicated, it transmits a notification to that effect to the cloud server 102 and terminates the PC processing. Therefore, each time a set of a series of sound information N is finalized, said series of sound information N is transmitted.

The cloud server processing will now be described. When a notification of a transition to the performance start state, the CPU 21 starts a series of processes (S502-S506) in Step S501. In Step S502, the CPU 21 receives the series of sound information N transmitted from the PC 101 in Step S404.

In Step S503, the CPU 21 (phrase generation unit 47) generates one phrase with respect to the current series of sound information N. The method is illustrated in an example below. For instance, the CPU 21 analyzes the accents of a series of sound information N from the velocity of each piece of sound information N and extracts from the phrase database 54 a phrase matching said accents and the number of syllables constituting the series of sound information N. In doing so, the extraction range can be narrowed down based on conditions. For example, the phrase database 54 can be categorized according to conditions and configured such that the user can set at least one condition, such as “noun,” “fruit,” “stationery,” “color,” “size,” etc, or more.

For example, consider the case in which there are four pieces of sound information N and the condition is “fruit.” If the analyzed accents are “strong/weak/weak/weak,” “durian” is extracted, and if the accents are “weak/strong/weak/weak,” “orange” is extracted. Consider the case in which there are four pieces of sound information N and the condition is “stationery.” If the analyzed accents are “strong/weak/weak/weak,” “compass” is extracted, and if the accents are “weak/strong/weak/weak,” “crayon” is extracted. Setting conditions is not essential.

In Step S504, the CPU 21 (synthesizing unit 45) synthesizes a singing sound from the generated phrase. The pitch of the singing sound can conform to the pitch of each syllable set in the phrase. In Step S505, the CPU 21 transmits the singing sound to the sound output device 103 via the various I/Fs 29.

In Step S506, the CPU 21 determines whether a notification of an end-of-performance instruction has been received from the PC 101. Then, if a notification of an end-of-performance instruction has not been received, the CPU 21 returns to Step S502. If a notification of an end-of-performance instruction has been received, the CPU 21 transmits the notification of the end-of-performance instruction and terminates the cloud server processing.

The sound output device processing will now be described. In Step S601, when the singing sound is received via the various I/Fs 39, the CPU 31 of the sound output device 103 proceeds to Step S602. In Step S602, the CPU 31 (output unit 46) outputs the singing sound that has been received. The output timing of each syllable depends on the input timing of the corresponding sound information N. Here, as in the first embodiment, the output mode is not limited to reproduction.

In Step S603, it is determined whether a notification of an end-of-performance instruction has been received from the cloud server 102. Then, if a notification of an end-of-performance instruction has not been received, the CPU 31 returns to Step S601, and if a notification of an end-of-performance instruction has been received, the CPU 31 terminates the sound output device processing. Therefore, the CPU 31 outputs each time the singing sound of the phrase is received.

By the present embodiment, it is possible to output singing sounds in accordance with the timing and intensity of the performance input.

In the present embodiment, since the striking of the head of the drum and its rim (rim shot) results in different timbres, this difference in timbre can also be used as a parameter for the phrase generation. For example, the above-described condition for phrase extraction can be varied between striking the head of the drum and a rim shot.

Sound generated by striking is not limited to that of a drum and can include hand clapping. When an electronic drum is used, the striking position on the head can be detected and the difference in the striking position can be used as a parameter for phrase generation.

In the present embodiment, if the sound information N that can be acquired includes pitch information, the high/low of the pitch can be replaced with an accent, and a similar processing as that of striking the drum can be executed. For example, when “do/mi/do” is played on a piano, a phrase that corresponds to playing “weak/strong/weak” on the drum can be extracted.

In the embodiments described above, if the sound output device 103 is provided with a plurality of singing voices (a plurality of genders, etc.), the singing voice to be used can be switched in accordance with sound information N. For example, if the sound information N is audio data, the singing voice can be switched in accordance with the timbre. If the sound information N is MIDI data, the singing voice can be switched in accordance with the timbre or other parameters set in the PC 101.

In the embodiments described above, it is not essential for the singing sound output system 1000 to include the PC 101, the cloud server 102, and the sound output device 103. It is also not limited to a system that goes through a cloud server. That is, each functional unit shown in FIG. 3 can be realized by any of the devices or a single device. If the functional units were to be realized by a single integrated device, the device need not be referred to as a singing sound output system, but can be referred to as a singing sound output device.

In the embodiments described above, at least some of the functional units shown in FIG. 3 can be realized by AI (Artificial Intelligence).

This disclosure was described above based on preferred embodiments, but this disclosure is not limited to the above-described embodiments and includes various embodiments that do not depart from the scope of the invention. Some of the above-described embodiments can be appropriately combined.

A storage medium that stores a control program represented by software for achieving this disclosure can be read into this disclosure to achieve the same effects of this disclosure, in which case the program code read from the storage medium realizes the novel functions of this disclosure, so that a non-transitory, computer-readable storage medium that stores the program code constitutes this disclosure. In addition, the program code can be supplied via a transmission medium, or the like, in which case the program code itself constitutes this disclosure. The storage medium in these cases can be, in addition to ROM, a floppy disk, a hard disk, an optical disc, a magneto-optical disk, a CD-ROM, a CD-R, magnetic tape, a non-volatile memory card, etc. The non-transitory, computer-readable storage medium includes storage media that retain programs for a set period of time, such as volatile memory (for example, DRAM (Dynamic Random-Access Memory)) inside a computer system that constitutes a server or client, when the program is transmitted via a network such as the Internet or a communication line, such as a telephone line.

### Effects

By one embodiment of this disclosure, it is possible to output a singing sound at a timing at which sound information is input, in synchronization with the accompaniment.

What is claimed is:

1. A singing sound output system comprising:
at least one processor configured to execute a plurality of units including
a teaching unit configured to indicate to a user a progression position in singing data that are temporally associated with accompaniment data and that include a plurality of syllables,
an acquisition unit configured to acquire at least one piece of sound information input by a performance,
a syllable identification unit configured to identify, from the plurality of syllables in the singing data, a syllable corresponding to the at least one piece of sound information acquired by the acquisition unit,
a timing identification unit configured to associate, with the at least one piece of sound information, relative information indicating a relative timing with respect to an identified syllable that has been identified by the syllable identification unit,
a synthesizing unit configured to synthesize a singing sound based on the identified syllable, and
an output unit configured to, based on the relative information, synchronize and output the singing sound synthesized by the synthesizing unit and an accompaniment sound based on the accompaniment data.

2. The singing sound output system according to claim 1, wherein
the at least one piece of sound information includes at least pitch information, and
the synthesizing unit is configured to synthesize the singing sound based on the identified syllable and the pitch information.

3. The singing sound output system according to claim 1, wherein
the teaching unit is configured to indicate the progression position on lyrics displayed corresponding to the plurality of syllables in the singing data.

4. The singing sound output system according to claim 1, wherein
the teaching unit is configured to reproduce the accompaniment data at a preset tempo to indicate the progression position in the singing data.

5. The singing sound output system according to claim 1, wherein
the syllable identification unit is configured to identify, as the syllable corresponding the at least one piece of sound information, a syllable for which a difference between a pronunciation start timing defined by a temporal correspondence relationship with the accompaniment data and an input start timing of the at least one piece of sound information is smallest among the plurality of syllables in the singing data.

6. The singing sound output system according to claim 5, wherein
the relative information is the difference.

7. The singing sound output system according to claim 1, wherein
the accompaniment data and the plurality of syllables in the singing data are temporally associated by timing information, and
the output unit is configured to output the singing sound, in parallel with output of the accompaniment sound, while adjusting an output timing of the singing sound based on the timing information and the relative information, to synchronize and output the singing sound and the accompaniment sound.

8. The singing sound output system according to claim 1, wherein
an order of the plurality of syllables in the singing data is set in advance,
the teaching unit is configured to indicate a next syllable in the singing data while awaiting input of the at least one piece of sound information, and in response to input of the at least one piece of sound information, the teaching unit is configured to advance an indication syllable that indicates the progression position by one to a following syllable following the indication syllable, and
the syllable identification unit is configured to identify the next syllable next in an order of progression at the time at which the at least one piece of sound information is input, as the syllable corresponding to the at least one piece of sound information that has been input.

9. The singing sound output system according to claim 8, wherein
the accompaniment data and the plurality of syllables in the singing data are temporally associated by timing information,
the timing identification unit is configured to obtain as the relative information a difference between a pronunciation start timing defined by a temporal correspondence relationship with the accompaniment data and an input start timing of the at least one piece of sound information for the identified syllable, and
the output unit is configured to output the singing sound and the accompaniment sound while adjusting an output timing of the singing sound and the accompaniment sound based on the timing information and the difference, to synchronize and output the singing sound and the accompaniment sound.

10. A singing sound output system comprising:
at least one processor configured to execute a plurality of units including
an acquisition unit configured to acquire a series of sound information including at least information indicating timing and information indicating velocity,
a phrase generation unit configured to analyze accents of the series of sound information based on the velocity of each piece of sound information in the series of sound information acquired by the acquisition unit, and generate a phrase including a plurality of syllables corresponding to the series of sound information based on the accents,
a synthesizing unit configured to synthesize a singing sound based on the plurality of syllables of the phrase generated by the phrase generation unit, and
an output unit configured to output the singing sound synthesized by the synthesizing unit.

11. The singing sound output system according to claim 10, wherein
the phrase generation unit is configured to extract the phrase matching the accents from a phrase database prepared in advance, to generate the phrase corresponding to the series of sound information.

12. A singing sound output method comprising:
indicating to a user a progression position in singing data that are temporally associated with accompaniment data and that include a plurality of syllables;
acquiring at least one piece of sound information input by a performance;
identifying, from the plurality of syllables in the singing data, a syllable corresponding to the at least one piece of sound information;
associating, with the at least one piece of sound information, relative information indicating a relative timing with respect to an identified syllable that has been identified;
synthesizing a singing sound based on the identified syllable; and
synchronizing and outputting, based on the relative information, the singing sound and an accompaniment sound based on the accompaniment data.

13. The singing sound output method according to claim 12, wherein
the at least one piece of sound information includes at least pitch information, and
the synthesizing of the singing sound is performed based on the identified syllable and the pitch information.

14. The singing sound output method according to claim 12, wherein
the indicating of the progression position is performed by indicating the progression position on lyrics displayed corresponding to the plurality of syllables in the singing data.

15. The singing sound output method according to claim 12, wherein
the indicating of the progression position is performed by reproducing the accompaniment data at a preset tempo.

16. The singing sound output method according to claim 12, wherein
the identifying of the syllable corresponding to the at least one piece of sound information is performed by identifying, as the syllable corresponding the at least one piece of sound information, a syllable for which a difference between a pronunciation start timing defined by a temporal correspondence relationship with the accompaniment data and an input start timing of the at least one piece of sound information is smallest among the plurality of syllables in the singing data.

17. The singing sound output method according to claim 16, wherein
the relative information is the difference.

18. The singing sound output method according to claim 12, wherein
the accompaniment data and the plurality of syllables in the singing data are temporally associated by timing information, and
in outputting of the singing sound, the synchronizing and the outputting of the singing sound and the accompaniment sound is performed by outputting the singing sound, in parallel with output of the accompaniment sound, while adjusting an output timing of the singing sound based on the timing information and the relative information.

19. The singing sound output method according to claim 12, wherein
an order of the plurality of syllables in the singing data is set in advance,
the indicating of the progression position is performed by indicating a next syllable in the singing data while awaiting input of the at least one piece of sound information, and advancing an indication syllable indicating the progression position by one to a following syllable following the indication syllable, in response to input of the at least one piece of sound information, and
the identifying of the syllable corresponding to the at least one piece of sound information is performed by identifying the next syllable next in an order of progression at the time at which the at least one piece of sound information is input, as the syllable corresponding to the at least one piece of sound information that has been input.

20. The singing sound output method according to claim 19, wherein
the accompaniment data and the plurality of syllables in the singing data are temporally associated by timing information, and
in the associating of the relative information with the at least one piece of sound information, a difference between a pronunciation start timing defined by a temporal correspondence relationship with the accompaniment data and an input start timing of the at least one piece of sound information for the identified syllable is obtained as the relative information, and
in the outputting of the singing sound, the synchronizing and the outputting of the singing sound is performed by outputting the singing sound and the accompaniment sound while adjusting an output timing of the singing sound and the accompaniment sound based on the timing information and the difference.
